(19) United States
(12) Patent Application Publication
(10) Pub. No.: US 2008/0060240 A1
(43) Pub. Date: Mar. 13, 2008

(54) Laser compatible business form having magnetic layer and method of using same

(75) Inventor: Jesse D. Crum, Fort Scott, KS (US)

Correspondence Address: Ward/Kraft, Inc.;Attn: Stephanie Hay, P.O. Box 938, 2401 Cooper St., Fort Scott, KS, 66701, US

(73) Assignee: Ward/Kraft, Inc.

(21) Appl. No.: 11/985,002

(22) Filed: Nov. 13, 2007

Related U.S. Application Data
(62) Division of application No. 10/691,265, filed on Oct. 22, 2003.

(51) Int. Cl. G09F 7/04

(52) U.S. Cl. 40/600; 229/92.8

(57) ABSTRACT

The present invention relates to a business form assembly containing a laser compatible magnetic layer. The business form assembly can be used for a variety of different industries such as business, marketing, advertising, retail, wholesale, personal, and the like. Through the use of a magnetic slurry, a magnetic portion can be created on the business form assembly enabling the assembly to be processed through a non-impact printer as well as to be attached to appliances and other metal surfaces to provide a convenient medium for conveying business or personalized messages. The present invention also provides for the creation of a plurality of separable magnetic elements that may match or cooperate with one or more separable printed portions on the substrate to create an individualized or specialized communication piece.

### CROSS-REFERENCES TO RELATED APPLICATIONS

This application is a divisional application of Ser. No. 10/691,265 filed Oct. 22, 2003.

### FIELD OF THE INVENTION

The present invention relates to a business form and/or business form with separable label and magnet combination which is printable though the use of a laser or other non-impact printer. The substrate of the present invention is intended to be provided with advertising indicia, marketing messages, remembrance details and the like, but may include other printing or indicia depending on the requirements of the end user. The form construction of the present invention includes a magnetic layer created through the use of a magnetic coating that is applied to the substrate and which may be then be optionally divided or sectioned to create additional separable magnetic elements which may denote separate offers, advertisers, promotions, pictures, etc. that may be adhered to ferromagnetic surfaces. The construction is unique and designed such that it may be processed through traditional down line equipment as well as, offline folding equipment. In addition, the business form of the present invention may also be folded to produce an outgoing mailer construction suitable for processing through the United States Postal Service.

### BACKGROUND OF THE INVENTION

Magnetic materials have become increasingly common in the business forms and labels industry. Today's growth of new technology plays a vital role in creating and providing businesses with laser compatible forms, which can be sued in a variety of businesses and industries. This present invention has a desired laser compatible substrate and a magnetic layer affixed thereto, that may be used for advertising and marketing, coupon redemption, message memos, emergency numbers, business and service references, photographs, rebates, etc.

Magnets have been previously attached to materials and used for purposes of marketing and advertising. Some exemplary prior uses of magnets include calendars, business cards, frames for photographs, advertising collateral and the like. One example of such a prior art construction is provided in U.S. Pat. No. 5,458,282. The construction includes a solid magnet that is attached to one end of a substrate and, placed between end edges of the substrate and before the separation line of the adjoining substrate section. The difficulty associated with such prior art constructions is that this construction is often limited in usage to the one advertising arrangement provided with the assembly. That is, the magnet may contain a single business card or reference or contact number and the adjoining substrate may only include printed indicia related to that one event.

Such single purpose forms aren't generally economical for use by small businesses or groups of business as minimum quantities of such products may require the purchase of several hundred or even several thousand, whereas a small business may only need a few dozen for selected customers, and then for those products to be potentially personalized.

In addition, to the foregoing drawback, such a construction also requires a magnetic piece to be physically affixed to a substrate in order to use the product for its intended purpose, that of enabling the substrate to be applied to a metallic surface. Due to the increased thickness of the magnetic material, the substrate with the magnet attached cannot easily pass through a laser or other non-impact printer due to the hump or bump created by the magnet. This hump can distort the printing of the substrate and potentially cause excessive wear and tear to the print head of the printer due to the abrupt contact with the raised area of the magnet. Thus, the substrate must first be printed and then have the magnetic piece attached thereto. As might be expected, this can create alignment problems if the magnetic material is applied to the incorrect area of the substrate.

More importantly however, the foregoing thus eliminates the ability for use of such products by small office/home office (“SOHO”) environments, as such environments would not have the desire to purchase rolls of magnetic material, cut the material to size and then affix the material to the substrate being printed. In addition, this prior art construction then virtually eliminates the ability to individually personalize such magnetic pieces, regardless of the size of the business.

What is needed therefore is an advertising piece that may be produced with variable information in one of a number of preconfigured formats and which does not suffer from the drawbacks enumerated above. In addition, there is a need for a magnetic promotional piece having an integral magnetic portion formed therewith that can be produced on an economical and efficient scale.

### BRIEF SUMMARY OF THE INVENTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

This present invention relates generally to a substrate having a non-impact printer (e.g. laser, ink jet) compatible magnetic layer disposed thereon through use of a coatable magnetic slurry. The present invention further includes the ability to provide a multiple segmented magnetic piece that may lend itself to several applications that has various industrial and business uses, including but not limited discrete warnings or messages, marketing and advertising articles, business and service references, coupons, greeting messages, promotional pieces, participation and attendance souvenirs, important address, phone, and fax number displays such as emergency, medical, etc. as well as personal application such as family photographs, images or personal messages.

The present invention overcomes prior art constructions relating to the “bump” created by the additional supplemental magnetic piece through the use of a magnetic layer that may be applied to a substrate in a single pass operation, while enabling the magnetic coated substrate to be utilized in non-impact printers for subsequent personalization.

In other embodiments of the present invention the construction may contain multiple sections, portions or pieces of non-magnetic substrate that can be used and implemented in a variety of ways to accomplish any number of operations or tasks the end-user may have. In addition, the magnetic coated portion of the substrate may also be partitioned, sectioned, etc. so that cooperating or matching magnetic components may be provided with related components or segments on the appended, printed or imaged substrate.

The present invention can be used in a variety of applications in such areas including, but not limited to, retail, marketing, wholesale, advertising, medical & emergency environments and the like.

The magnetic layer of the present invention may be placed at any pre-determined portion or zone of the substrate thus further lending itself to providing a highly variable construction for the end user or recipient. That is, the magnetic layer and/or layers can be placed in a variety of arrangements with predetermined shapes and sizes of both magnetic and non-magnetic substrate. As the magnetic material is applied in the form of a slurry, various patterns can be produced such as geometric shapes and designs as well as characters, animate and inanimate to create an aesthetically appealing presentation piece for not only the manufacturer by also the end user. It should be understood that the magnetic layer and non-magnetic substrate can be provided in a variety of lengths, widths, shapes, sizea, forms, designs, etc.

In a further explained embodiment of the present invention the non-impact printer compatible magnetic piece is described and includes a substrate that has first and second faces having longitudinally extending sides and transversely extending end edges. One of the first and second faces has a first area that can receive indicia and the other of the faces has a second area capable of being coated with a magnetic slurry. The magnetic slurry and substrate creates a substantially planar arrangement that is generally flat and which can be processed through a non-impact printer, such as an ink jet or laser printer.

In one exemplary embodiment of the present invention, a business form with a magnetic portion is described and includes an elongated substrate having first and second faces and first and second longitudinally extending sides and first and second transversely extending end edges. The substrate is divided into at least first and second sections. A magnetic slurry is also provided in the presently described embodiment and is coated on at least one of the first and second sections on at least one of the first and second faces. The magnetic slurry and one of the first and second sections form a magnetic portion that may be applied to a metal or other surface capable of receiving magnetic material. The magnetic portion with the substrate provides a substantially planar configuration that can be processed through a non-impact printer.

In a yet still further embodiment of the present invention, a magnetic advertising assembly is provided and includes a substrate that has first and second surfaces and at least a first line of weakness that divides the substrate into first and second sections. Each of the first and second sections is provided with indicia representative of a promotional offer, personal message, business communication and combinations thereof. One of the first and second sections has at least one line of weakness that divides the section into first and second message portions, with each of the message portions containing a distinct message or offer.

The presently described embodiment also includes a magnetic slurry that is coated on at least one of the first and second surfaces so as to create a substantially planar advertising assembly that can be processed through a non-impact printer. The magnetic slurry with one of the first and second sections of the substrate forms a magnetic portion of the assembly.

Still continuing with the presently described embodiment of the present invention, the magnetic portion has at least one line of weakness that divides the magnetic portion into first and second sections, with each of the first and second sections having a distinct message or offer provided thereon. One of the first and second magnetic sections with its distinct offer thereon corresponds to the distinct message on one of the first and second message portions and the distinct message or offer on another of the first and second magnetic sections corresponds with another of the first and second message portions.

In a yet still further embodiment of the present invention, a mailer assembly having a magnetic portion, is described and includes a substrate having at least first, second and third panels, with one of the panels having a magnetic slurry applied thereto to create a magnetic portion. The substrate further has first and second surfaces, with one of the first and second surfaces forming an exterior of an outgoing mail piece and another of the first and second surfaces forming an internal portion of the mail piece. Each of the first and second surfaces has indicia applied thereto. The magnetic portion cooperating with the substrate to create a substantially planar surface that may be processed through a non-impact printer. When creating the outgoing mail piece, the magnetic portion is folded over onto the second panel and a remaining panel of the first, second and third panels is then folded or wrapped about the magnetic portion so as to enclose the magnetic portion in the outgoing mail piece.

In a yet still further embodiment of the present invention a ferromagnetic slurry for use in creating indicia for a communication document is described and includes a ferrite power provided in an amount ranging from about 50 to about 90% by weight of the slurry and more preferably from about 50 to about 70% by weight; a stabilizer provided in an amount ranging from about 5 to about 20% by weight of the slurry; a varnish provided in an amount ranging from about 15 to about 30% by weight of the slurry and the slurry is curable.

### BRIEF DESCRIPTION OF THE DRAWINGS

These, as well as, other objects and advantages of this invention, will be more completely understood and appreciated by referring to the following more detailed description of the presently preferred exemplary embodiments of the invention in conjunction with the accompanying drawings, of which:

FIG. 1 depicts a front view of the present invention and provides for the areas of the magnetic coating and non-magnetic portions of the assembly;

FIG. 2 illustrates a further view of the present invention and includes a number of separable sections as well as the magnetic portion;

FIG. 3 shows a further embodiment of the present invention and includes a sectionalized magnetic portion provided with unique indicia in each panel and a non-magnetic sectionalized portion with sectional indicia matching that which is provided in connection with the magnetic portion;

FIG. 4 provides a side view of the present invention and further illustrates the various layers used in the construction of the assembly;

FIG. 5 depicts the present invention configured as an outgoing mailer; and

FIG. 5A illustrates a side view of the present invention showing the panels of the assembly in a folded mailer configuration format.

### DETAILED DESCRIPTION OF THE INVENTION

The present invention is now illustrated in greater detail by way of the following detailed description, but it should be understood that the present invention is not to be construed as being limited thereto.

The term magnetic or ferromagnetic slurry as used herein, refers to a slurry that is applied in-line during printing operations and undergoes several processing steps prior to reaching its final destination.

Application of the magnetic slurry of the present invention may be accomplished by any suitable means such as flexographic, electrostatic, gravure, ion or electronic charge deposition, electro-coagulation printing and the like. Generally, however, printing of the present invention of an exemplary embodiment is done by applying a charge to an imaging drum which then removes an amount of material from a reservoir and applies a corresponding image to a substrate passing beneath the drum.

In one exemplary embodiment of the present invention, the slurry is curable by ultraviolet energy (UV curable) and includes as an exemplary formulation 410 Ferrite Powder, 30 LI Varnish, and a stabilizer additive which gives the invention its unique capability of being able to bind and adhere to substrates during a printing operation.

In one embodiment of the present invention, and exemplary formula includes the following components. Approximately 50-70% of 410 Ferrite Powder by weight of the slurry with about 60-65% by weight being preferred, and about 61-63% by weight being more preferred. Roughly 5-20% of a stabilizer, such as corn starch, by weight of the slurry with approximately 10-15% being preferred and 11-13% being more preferred. Approximately 15-30% by weight of the slurry of 30 LI Varnish with about 20-27% by weight of the slurry being preferred and about 23-26% by weight being more preferred. The 410 Ferrite powder is available from Hoosier Magnetics, Inc., Holland, Ohio; the 30 LI Varnish is available from North West Coatings, Oak Creek, Wis. and the stabilizer, corn starch is available from any retail outlet, such as grocery stores.

The slurry of the present invention is formulated so that the slurry once coated, applied, printed or imaged on the product is UV curable. Application of the slurry to a substrate, after curing results in a layer of cured ferromagnetic material having a thickness ranging from about 0.5 mil to about 25 mil and more preferably the cured thickness of the ferromagnetic material is in the range of about 1 to about 15 mil thickness and still more preferably in the range of approximately 2 to 12 mil thickness.

UV curing is a technology that regularly evolves and efforts are continually sought out in order to achieve improved curing performance so that the printing operation may proceed at optimum speeds. That is, UV curing typically requires a “dwell time” in which the UV curable substance dries before it can be further processed in any additional equipment. As such, it is preferable to achieve faster curing speeds under a variety of difficult and complex environments so as to minimize if not completely eliminate the need for dwell or drying time.

Exemplary bulbs used in curing the slurry of the present invention are “H” bulbs and Gallium doped bulb suitable for use in the UV curing processes described herein, however, it should be understood that other UV curing may be used in accordance with the present invention and the present invention is not limited hereto.

The “H” bulb is generally known as a mercury vapor bulb and is used typically for top surface curing applications. The Gallium doped bulb is used in connection with a requirement for penetrating deep within the slurry mix. The UV bulbs such as those described above along with reflectors are available from the GEW Company, located in North Royalton, Ohio. The combination of topical and penetration curing result in a combination of curing energies sufficient to carry out the present invention.

The process of applying the magnetic slurry is generally described as follows. The substrate which may either be a supply of cut sheet stock or alternatively, a continuous stock such as provided from a roll of material and is supplied to the coating apparatus. The ferromagnetic material is applied to the substrate through the use of a reservoir or well that has been previously filled with a ferromagnetic material, as described above (ferrite powder, stabilizer and a varnish). An image (geometric shape, animate or inanimate shape or simple block pattern) may be created through use of a cylinder, by means of surface tension, which helps create the image configuration, and picks up the UV curable magnetic or ferromagnetic slurry from reservoir. The magnetic slurry adheres to a roller by a charge, surface tension or other means known in the art.

Next, the roller transfers the magnetic slurry material to a print cylinder which has a magnetic plate affixed to the surface of the print cylinder. The magnetic plate then transfers the magnetic slurry to the desired area of the substrate.

An additional magnetic cylinder may be provided and disposed beneath the substrate and in operative association with the print cylinder. The magnetic cylinder aids in pulling the magnetic slurry to the predetermined position on the substrate. The magnetic cylinder also provides for and maintains a consistent transfer of the UV curable magnetic slurry to the substrate.

Once the magnetic slurry is affixed to the substrate, the substrate with the slurry applied then passes through at least one if not additional UV curing stations which contain UV bulbs for curing purposes.

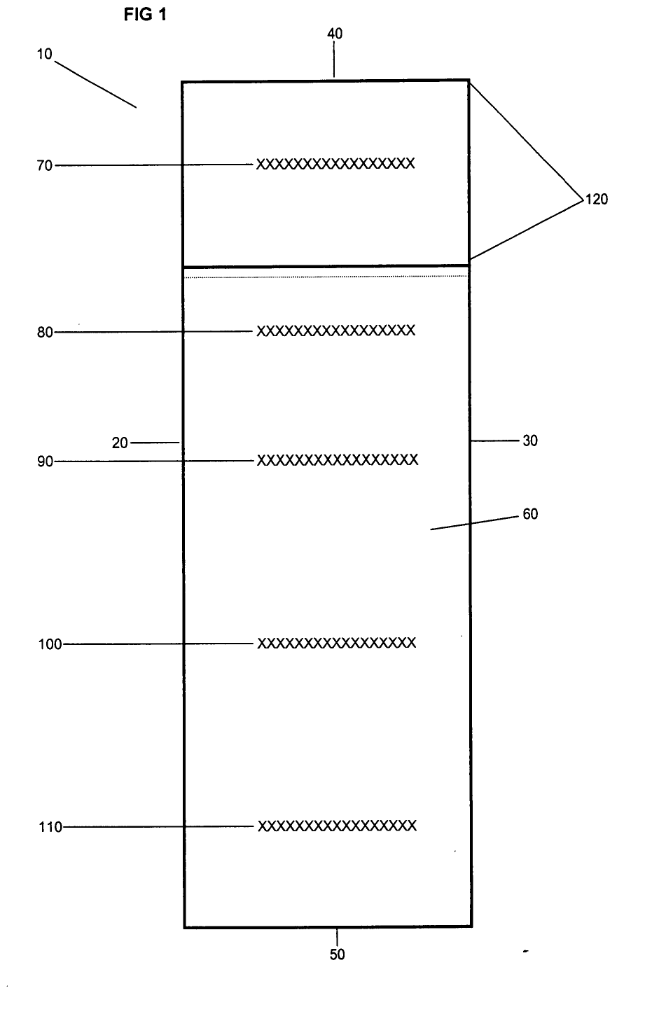

Turning now to FIG. 1 the present invention is generally represented by reference to 10. The substrate assembly 10 has first and second longitudinally extending sides 20 and 30 and first and second transversely extending end edges 40 and 50. Numeral 60 depicts the front face or surface of the present invention. The substrate should be one which is capable of receiving printing on both sides. FIG. 1 however, shows printing in optional pre-determined areas, 80, 90, 100 and 110. Numeral 120 depicts an exemplary predetermined location wherein the magnetic layer or slurry is placed on the substrate as described above.

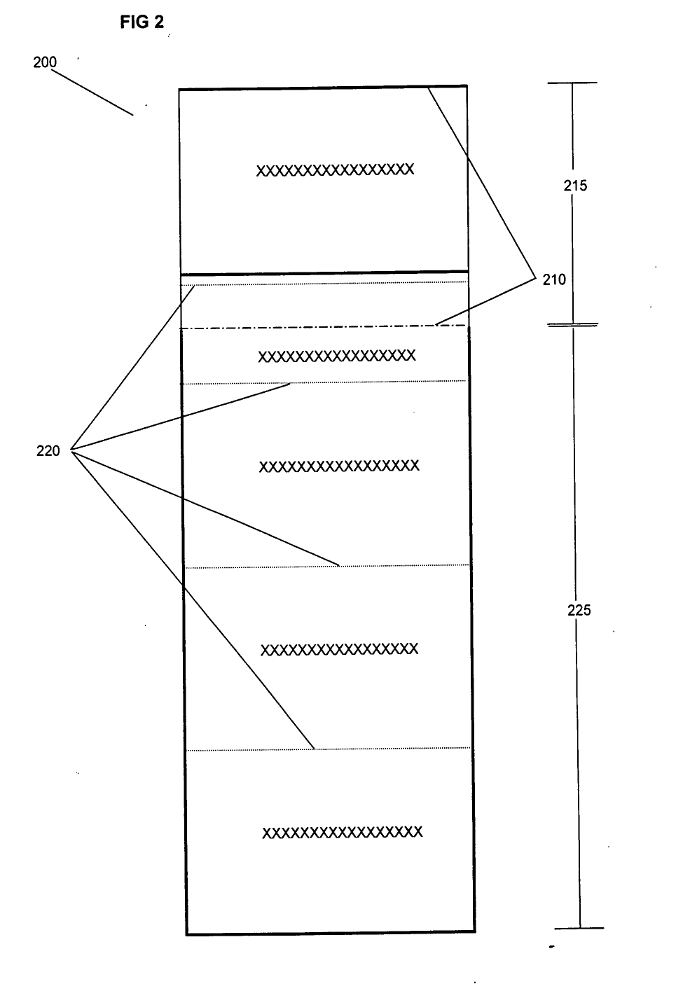

Reference is now directed to FIG. 2 of the present invention, and an exemplary embodiment of the product produced in accordance therewith is depicted generally by reference to numeral 200. Of course, any substrate can be used, such as 20 pound bond up to 100 pound tag available from Clayton Papers, Independence, Mo. The assembly 200 has a first area 215 and a second area 225 which is provided with a plurality of perforations 220 extending longitudinal side to longitudinal side. The lines of weakness 220 separate the second area 225 into a series of individual message areas that can be provided with individual or distinct messages, one from another. In addition, one line of weakness is used to divide the top section 215 from the bottom section 225.

The top section in the exemplary embodiment depicted includes the laser compatible magnetic portion, which is contained within the area designated as 210 (substrate with the cured magnetic slurry applied) and the lower section 225 is also laser compatible. Each of the sections is intended to receive indicia. The message sections created by the plurality of lines of weakness 220, preferably perforations, may be used to accommodate a variety of different sizes of coupons, advertisements, messages, and the like. The lines of perforations 220 also may be placed in any given arrangement in order to accommodate the end users applications and/or requirements.

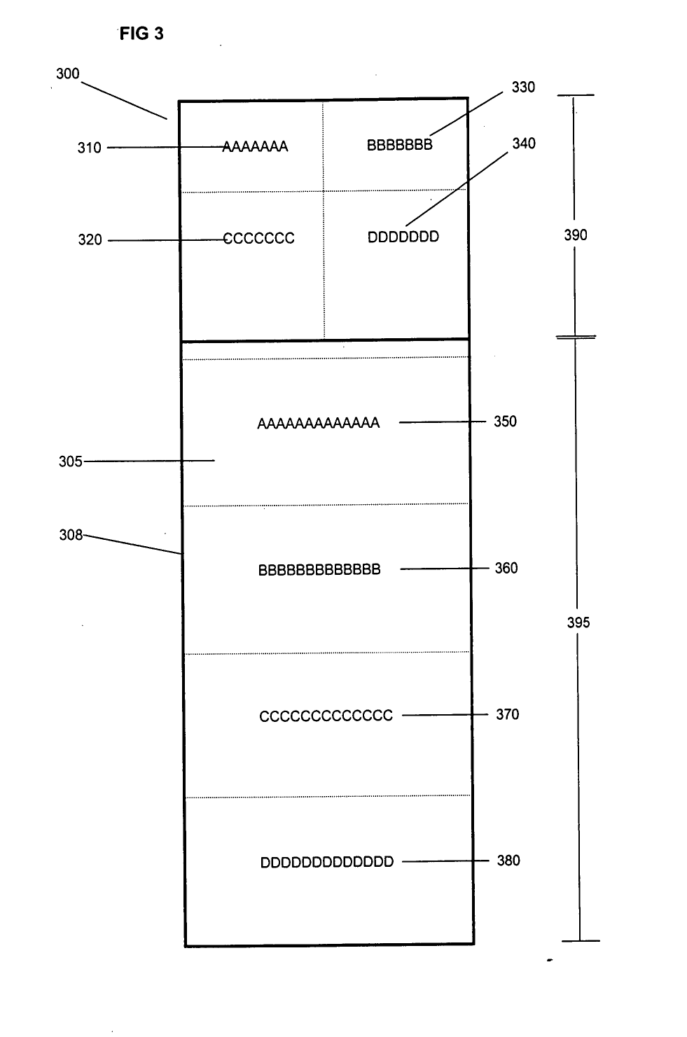

Turning now to FIG. 3. Numeral 300 depicts another exemplary embodiment of the present invention. The first face or surface of the substrate is depicted generally by reference to numeral 305 and 308 appears as the second face on the obverse side (not shown). Numerals 310, 320, 330, and 340 are provided and show individual magnetic sections to which distinct indicia or messages have been applied. Reference numerals 350, 360, 370, and 380 provide for distinct message areas on the second portion of the substrate 395.

In this embodiment, the magnetic portion 390 is separated by lines of weakness that include a first line of weakness and a second line of weakness running substantially perpendicular to the first line of weakness thus dividing the magnetic portion 390 into four substantially quadrate sections. As is shown by the FIG. 2, the sections are unequal, but it should be understood that the sections can be of equal size or of any size depending on the user. For example, if the advertising assembly were to be distributed by a series of small business owners (4), each of the sizes of the sections would be proportionate to the contribution made to the purchase of the assembly. Those business owners purchasing or contributing more to the purchase would receive a larger block, whereas those contributing less would receive a smaller block of the magnetic portion 390, such as is illustrated by reference to the blocks, 310, 320, 330 and 340.

Section 395 of the assembly 300 is provided with indicia that matches the respective blocks in the magnetic portion 390. That is block 350 matches with block or indicia 310, 360 corresponds to indicia 330, 370 relates to indicia 320 and 380 pertains to indicia or block 340. In this way, each of the advertisers is also provided with a coupon or message section for use with their advertising.

In an alternate embodiment, the sections in the magnetic portion 390 could be used by a single advertiser such as a fast food delivery service and each section would correspond to a different night of the week for a different special. For instance, Monday night may enable the caller to receive a large pizza at a special price. Tuesday night may entitle the user to receive a free drink with an order of Buffalo wings, etc. In this way, after the coupons or message sections in second area 395 have been used up, the recipient still has the separable magnet sections to remind him or her of the specials being offered in the evening.

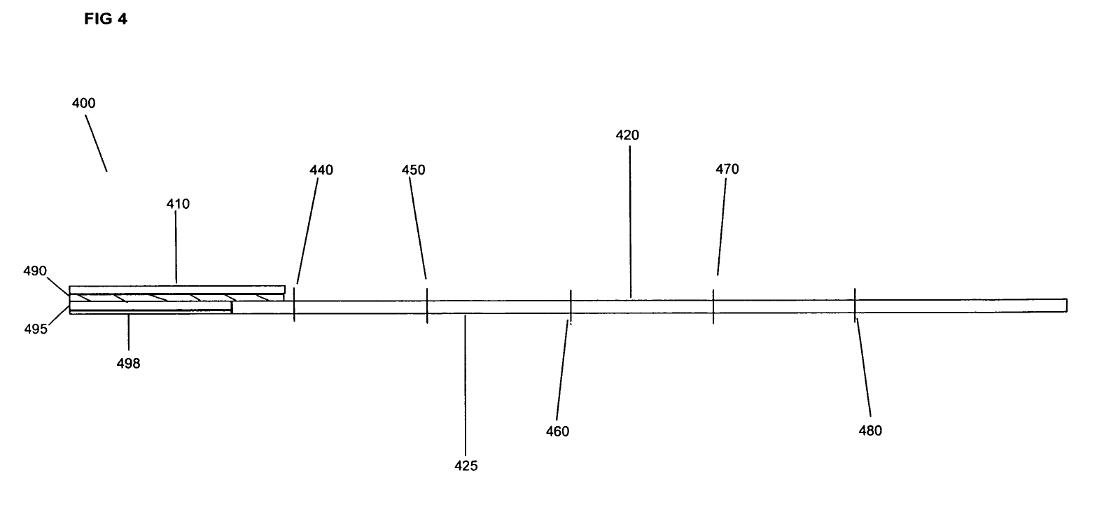

FIG. 4, depicts a side view of the present invention. Numeral 400 refers generally to the assembly of the present invention. Numeral 420 is depicted as the first face of the substrate and numeral 425 is depicted as a second face of the substrate. Numeral 410 is depicted as a substrate that can be placed on top of the first face of the primary substrate, such as a further detachable label or the like but 410 may also give additional support to the magnetic layer, 495. Reference numerals 440, 450, 460, 470 and 480 are depicted as first, second, third, fourth and fifth lines of weakness in the substrate, wherein these lines of weakness can be perforations, score lines or any other suitable means for accomplishing the purpose of folding or separation of the assembly. The lines of weakness can be placed in any position of the form assembly, in order to accommodate a diverse display of coupons, advertisements, messages, and the like.

Now turning back to numeral 410 and 495, you'll note that these substrates are applied to the first face and second face of the primary substrate. In order to make this happen, an adhesive, 490 may be used to accomplish the attachment of label or supporting structure 410 to the substrate. Also as shown in FIG. 4, the magnetic material 495 may be provided with an over coating or varnish 498 which may impart certain glossy or printability characteristics to the magnetic material. The varnish may be a UV curable varnish, such as UV30LI available from Northwest Coatings as indicated above.

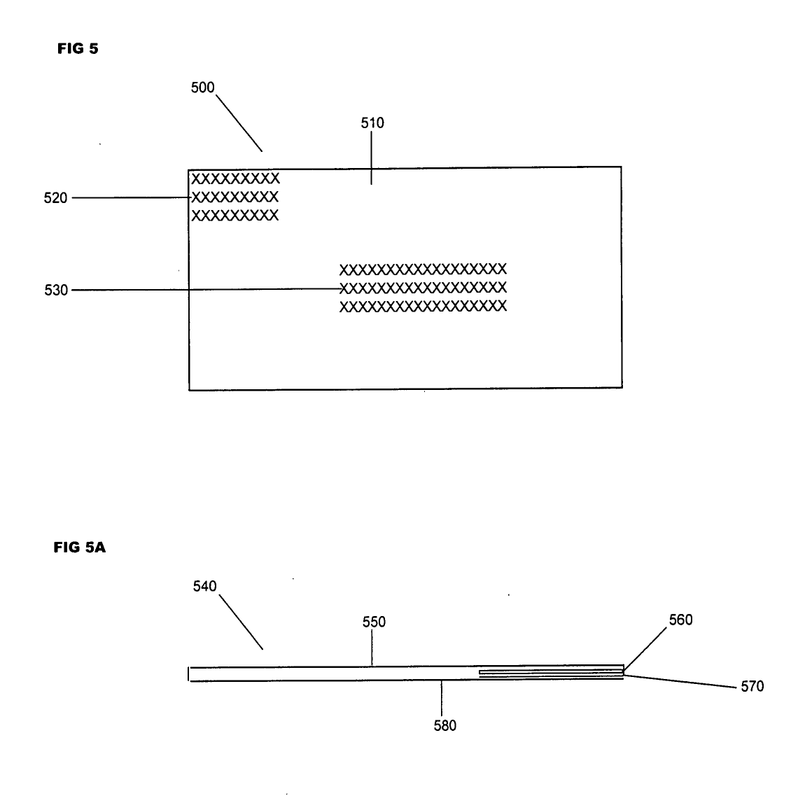

FIG. 5 of the present invention shows the substrate folded into a mailer assembly for an outgoing mail piece and is depicted by reference to numeral 500. The mail piece is provided with relevant postal indicia such as outgoing and return address information 530 and 520, respectively.

In order to create the mailing assembly, first, second and third panels are generally used and created by the lines of weakness in the substrate. Once the magnetic slurry has been applied, for instance to a first panel, looking at FIG. 4 with the magnetic portion to the left, the magnetic portion is folded over on to the second panel or central portion of the assembly using one or more of the lines of weakness (see FIG. 4). Next the remaining panel or the third panel is folded over or folded about the first (magnetic panel) so as to enclosed the magnetic portion as shown in FIG. 5A. The magnetic material is generally enclosed within the mailer, except that the side edges may be visible as provide din FIG. 5A.

FIG. 5A shows the side view of the mailer generally as 540. The magnetic portion or first panel 560, with the removable label 570 is folded over on to the second panel 580. Then the third or remaining panel 550 is folded over the first panel 560 with the magnetic portion (and label portion 570) and essentially lays over the second panel 580 creating the outgoing mail piece.

It should be understood that the internal portion of the mail piece or mailer assembly is formed from the first face of the substrate and the outgoing or external portion of the mailer is formed from the second face or back side of the substrate. The mailer assembly can be imaged on one or both sides and may include the imaging embodiments of the previously described arrangements where matching or cooperating messages are provided on the magnetic portion and the printed portion of the substrate.

It will thus be seen according to the present invention that a highly advantageous lay flat piece with a laser compatible magnetic material has been provided. While the invention has been described in connection with what is presently considered to be the most practical and preferred embodiment, it will be apparent to those of ordinary skill in the art that the invention is not to be limited to the disclosed embodiment and that many modifications and equivalent arrangements may be made thereof within the scope of the invention. The scope is to be accorded the broadest interpretation of the appended claims so as to encompass all equivalent structures and products.

The inventors hereby state their intent to rely on the Doctrine of Equivalents to determine and assess the reasonably fair scope of their invention as it pertains to any apparatus, system, method or article not materially departing from but outside the literal scope of the invention, as set out in the following claims.

1. A magnetic advertising assembly, comprising;
a) a substrate having first and second surfaces and at least a first line of weakness dividing said substrate into first and second sections;
b) each of said first and second sections is provided with indicia representative of a promotional offer, personal message, business communication and combinations thereof;
c) one of said first and second sections having at least one line of weakness dividing said one section into first and second message portions, with each of said message portions containing a distinct message or offer;
d) a magnetic slurry coated on at least one of said first and second surfaces so as to create a substantially planar advertising assembly that can be processed through a non-impact printer, said magnetic slurry with said one of said first and second sections of said substrate forming a magnetic portion of the assembly;
e) said magnetic portion having at least one line of weakness dividing said magnetic portion into first and second sections, with each of said first and second sections having a distinct message or offer provided thereon; and
f) one of said first and second magnetic sections with said distinct offer thereon corresponds to said distinct message on one of said first and second message portions and said distinct message or offer on another of said first and second magnetic sections corresponds with another of said first and second message portions.

2. A magnetic advertising assembly as recited in claim 1, wherein said magnetic portion is provided with a second line of weakness running substantially perpendicular to said first line of weakness to divide said magnet portion into substantially quadrate sections.

3. A magnetic advertising assembly as recited in claim 1, wherein said one of said first and second portions having said line of weakness therein is provided with a second and third line of weakness to create additional message portions, each of which has a distinct message thereon.

4. A magnetic advertising assembly as recited in claim 1, wherein said magnetic slurry includes a ferrite power provided in an amount ranging from about 50 to 90% by weight of the slurry;
a) a stabilizer provided in an amount ranging from about 5 to about 20% by weight of the slurry; and
b) a varnish provided in an amount ranging form about 15 to about 30% by weight of the slurry.

5. A mailer assembly having a magnetic portion, comprising;
a) a substrate having at least first, second and third panels, one of said panels having a magnetic slurry applied thereto to create a magnetic portion;
b) said substrate having a first and second surfaces, one of said first and second surfaces forming an exterior of an outgoing mail piece and another of said first and second surfaces forming an internal portion of said mail piece, each of said first and second surfaces having indicia applied thereto;
c) said magnetic portion cooperating with said substrate to create a substantially planar surface that may be processed through a non-impact printer; and
d) said magnetic portion is folded over onto said second panel and a remaining panel of said first, second and third panels is folded about said magnetic portion so as to enclose said magnetic portion in said outgoing mail piece.

6. A mailer assembly as provided in claim 5, wherein said substrate is provided with at least a first line of weakness so as to be able to separate said magnetic portion from said substrate.

7. A mailer assembly as provided in claim 5, wherein said magnetic portion is provided with at least one line of weakness so as to create two separable portions of said magnetic portion, with each portion having indicia relating to a promotion or offer.

8. A mailer assembly as recited in claim 5, wherein said substrate is provided with a plurality of lines of weakness creating individual, separable promotional or offer sections that may be separated from said substrate.

9. A mailer assembly as recited in claim 5, wherein said magnetic slurry includes a ferrite power provided in an amount ranging form about 50 to about 90% by weight of the slurry;
a) a stabilizer provided in an amount ranging from about 5 to about 20% by weight of the slurry; and
b) a varnish provided in an amount ranging from about 15 to about 30% by weight of the slurry.

10. A mailer assembly as recited in claim 9, wherein said magnetic slurry is curably by ultraviolet radiation.

11. A magnetic mailer form for use with non-impact printers, comprising:
a) a sheet of printable material having first and second ends, front and rear surfaces, and a predetermined thickness;
b) a layer of magnetic material disposed on an area of said front surface adjacent said second end, said magnetic material being of a thickness substantially equal to said predetermined thickness;
c) a label overlying said magnetic material and a portion of said front surface outside of said area, said label being removably adhesively secured to said magnetic material and said front surface;
d) lines of weakness so formed in said sheet as to allow said label and magnetic material to be folded over the middle portion of said front face adjacent to said label, and to allow the portion of said sheet adjacent said first end to be folded over said middle portion so as to produce a mailer enclosing said magnetic material and label between non-magnetic portions of said sheet.

12. The mailer of claim 1 1, further comprising a coating over said magnetic material adapted to enhance the printability of said magnetic material.

13. The mailer of claim 11, in which consumer-related indicia are disposed on said first face, and mail-related indicia are disposed on said second face.

14. The mailer of claim 11, in which said thicknesses are substantially 0.5 mil to 25 mil.

15. The mailer of claim 1 1, in which said thicknesses are substantially 2 to 12 mil.
